(19) United States
(12) Patent Application Publication
(10) Pub. No.: US 2021/0136034 A1
(43) Pub. Date: May 6, 2021

(54) COMMUNICATION CONTROL METHOD, STORAGE MEDIUM FOR COMMUNICATION CONTROL PROGRAM, AND COMMUNICATION APPARATUS

(71) Applicant: NEC CORPORATION, Tokyo (JP)

(72) Inventors: Takeshi HAYASHI, Tokyo (JP); Tsukasa KOBAYASHI, Tokyo (JP)

(73) Assignee: NEC CORPORATION, Tokyo (JP)

(21) Appl. No.: 16/491,962

(22) PCT Filed: Mar. 5, 2018
(86) PCT No.: PCT/JP2018/008263

§ 371 Date: Sep. 6, 2019

(30) Foreign Application Priority Data
Mar. 6, 2017 (JP) 2017-041347

(51) Int. Cl. H04L 29/12; G06F 13/42; G06F 13/12

(52) U.S. Cl. CPC H04L 61/6063; G06F 13/122; G06F 13/4282

(57) ABSTRACT

A communication apparatus according to an example embodiment of the present invention that performs a communication application configured to control communication and has a physical connection portion includes a communication information acquisition unit that acquires a combination of the physical connection portion and the communication application used for the communication performed from a device connected to the physical connection portion to the outside; and a communication determination unit that determines whether or not to permit the communication based on the combination used for the communication and a combination of the physical connection portion and the communication application registered in advance.

### TECHNICAL FIELD

The present invention relates to a communication control method, a storage medium for a communication control program, and a communication apparatus.

### BACKGROUND ART

In recent years, Internet of Things (IoT) is drawing attention. In IoT, various devices such as a sensor, an actuator, or the like can be connected to a network such as the Internet, and it is possible to monitor and analyze data acquired from a device or control the operation of a device via the network.

Communication performed by a device is often controlled by an application executed on a communication apparatus such as a gateway to which the device is connected. Conventionally, devices are not connected to a network or are connected to an isolated network such as a local area network (LAN), and thereby there is less concern about security. In IoT, however, in particular when a device is connected to the Internet accessed by unspecified users, a new threat in security occurs. Thus, there is a demand for improving security of devices connected to a network.

Patent Literature 1 discloses a technology that restricts execution of an application based on a reputation of the application determined by another user.

Patent Literature 2 discloses a technology that detects execution of an unauthorized computer program (malware) based on a communication protocol and a virtual port number used for communication.

### CITATION LIST

### Patent Literature

PTL 1: Japanese Patent Application Laid-Open No. 2010-079901

PTL 2: Japanese Patent Application Laid-Open No. 2013-011948

### SUMMARY OF INVENTION

### Technical Problem

In a communication apparatus such as a gateway to which various types of devices may be connected, various types of applications are executed in accordance with a device to be controlled. The device may be an IP device that performs communication by using a communication protocol of Transmission Control Protocol/Internet Protocol (TCP/IP), which is typically used on the internet, and a non-IP device that performs communication by using a communication protocol other than the TCP/IP.

In the technology disclosed in Patent Literature 1, since execution is restricted on an application basis, it is not possible to perform detail restriction for each device controlled by the application. Even when an application can control communication of multiple types of devices, for example, the application simply either permits or rejects communication for all the types of devices.

The technology disclosed in Patent Literature 2 requires a use of an IP device that communicates in accordance with a communication protocol using a virtual port and therefore cannot be applied to a non-IP device that does not use a virtual port.

The present invention has been made in view of the problems described above and intends to provide a communication control method, a storage medium of a communication control program, and a communication apparatus capable of performing detail communication control regardless of whether the device is an IP device or a non-IP device.

A first example aspect of the present invention is a communication control method having steps of: acquiring, at a communication apparatus that executes a communication application configured to control communication and has a physical connection portion, a combination of the physical connection portion and the communication application used for the communication performed from a device connected to the physical connection portion to outside of the communication apparatus; and determining whether or not to permit the communication based on the combination used for the communication and a combination of the physical connection portion and the communication application registered in advance.

A second example aspect of the present invention is a storage medium in which a communication control program is stored that causes a communication apparatus that is a computer that executes a communication application configured to control communication and has a physical connection portion to perform the steps of: acquiring a combination of the physical connection portion and the communication application used for the communication performed from a device connected to the physical connection portion to outside of the communication apparatus; and determining whether or not to permit the communication based on the combination used for the communication and a combination of the physical connection portion and the communication application registered in advance.

A third example aspect of the present invention is a communication apparatus that performs a communication application configured to control communication and has a physical connection portion including: a communication information acquisition unit that acquires a combination of the physical connection portion and the communication application used for the communication performed from a device connected to the physical connection portion to outside of the communication apparatus; and a communication determination unit that determines whether or not to permit the communication based on the combination used for the communication and a combination of the physical connection portion and the communication application registered in advance.

According to the present invention, since communication control is performed based on a combination of a physical connection portion to which the device is connected and a communication application used by the device, it is possible to perform detail communication control regardless of whether the device is an IP device or a non-IP device.

### BRIEF DESCRIPTION OF DRAWINGS

FIG. 1 is a schematic diagram of a communication method using a communication apparatus according to a first example embodiment.

FIG. 2 is a block diagram of the communication apparatus according to the first example embodiment.

FIG. 3 is a schematic diagram of a combination table registered in a combination table storage unit according to the first example embodiment.

FIG. 4 is a general configuration diagram illustrating a device configuration of the communication apparatus according to the first example embodiment.

FIG. 5 is a diagram illustrating a flowchart of a communication control method according to the first example embodiment.

FIG. 6 is a schematic diagram of a combination table registered in a combination table storage unit according to a second example embodiment.

FIG. 7 is a diagram illustrating a flowchart of a communication control method according to the second example embodiment.

FIG. 8 is a diagram illustrating a flowchart of a communication control method according to a third example embodiment.

FIG. 9 is a general configuration diagram of a communication apparatus according to each example embodiment.

### DESCRIPTION OF EMBODIMENTS

While example embodiments of the present invention will be described below with reference to the drawings, the present invention is not limited to the present example embodiments. Note that, in the drawings described below, components having the same function are labeled with the same reference, and the duplicated description thereof may be omitted.

### First Example Embodiment

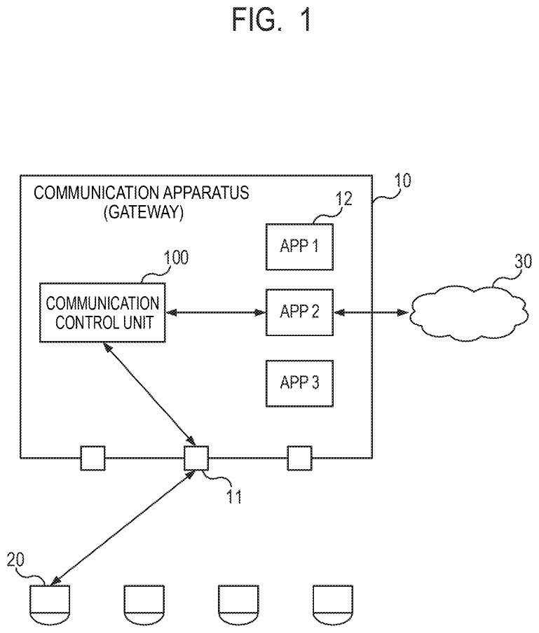

FIG. 1 is a schematic diagram of a communication method that uses a communication apparatus 10 according to the present example embodiment. The communication apparatus 10 is also referred to as a gateway, which is a device that controls communication between a device 20 and an external device 30 via a network. At least two physical ports 11, which are physical connection portions, are provided on the communication apparatus 10, and the device 20 may be connected to the physical port 11. The physical port 11 as a physical connection portion is an interface used for physically connecting the device 20 via a connecting member such as a cable, a connector, or the like, and is different from a virtual port used by a program to specify the destination of data. As the physical port 11, for example, a serial port (COM port) of RS-232C standard, RS-422 standard, RS-485 standard, or the like, a parallel port of IEEE-1284 standard, a Universal Serial Bus (USB) port, or any other physical interfaces may be used.

The external device 30 is a device that is connected to the communication apparatus 10 via a network. The external device 30 may be a computer or a cloud, for example, which is a collection of computer resources.

The device 20 is a device that transmits a predetermined signal to the external device 30 or performs a predetermined operation in response to a signal from the external device 30. For example, the device 20 is a sensor that measures a temperature, a pressure, a sound, or the like, and the device 20 transmits a signal that represents a measurement result to the external device 30 in this case. For example, the device 20 is an actuator that performs a predetermined operation, and the device 20 operates in accordance with a signal that indicates a control content received from the external device 30 in this case. The device 20 may be an IP device that performs communication by using the TCP/IP communication protocol and a non-IP device that performs communication by using a communication protocol other than the TCP/IP.

A communication application 12 is a computer program that controls communication performed by the device 20. The device 20 performs communication in accordance with a communication protocol different for types or manufacturers. The communication protocol to which the device 20 conforms may be, for example, a typical protocol such as the TCP/IP or a unique protocol that differs depending on the type or the manufacturer of the device 20. The communication application 12 performs conversion of a signal transmitted and received between the device 20 and the external device 30 in accordance with the communication protocol to which the device 20 conforms.

The communication application 12 is prepared in advance in association with the device 20 that may be connected to the communication apparatus 10. The communication apparatus 10 executes the communication application 12 associated with the actually connected device 20. The communication apparatus 10 may internally pre-store the communication application 12 associated with the device 20 or may externally acquire the communication application 12 when the device 20 is connected to the communication apparatus 10. That is, when the device 20 is connected to the communication apparatus 10, the communication apparatus 10 acquires the communication application 12 used by the device 20 from the inside or outside of the communication apparatus 10 and executes the communication application 12.

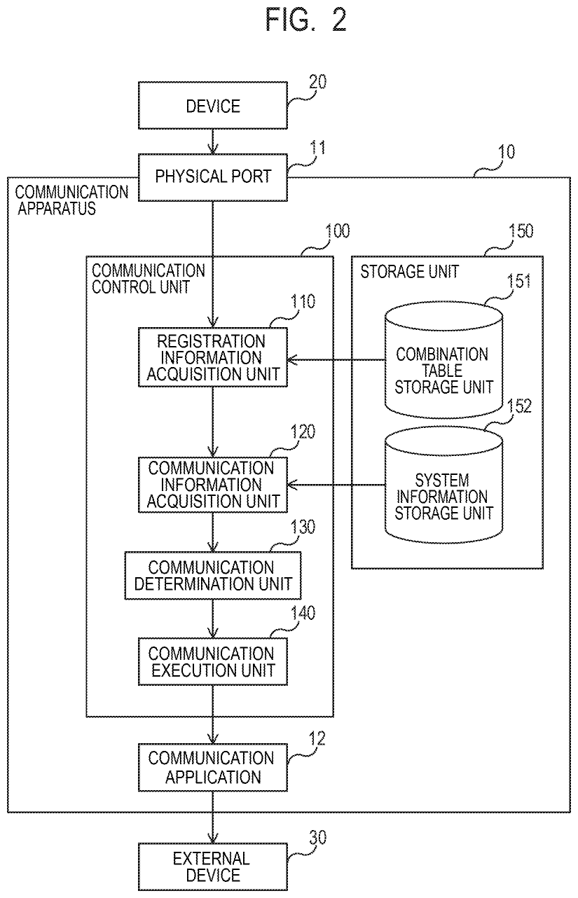

A communication control unit 100 controls communication of the device 20 that uses the communication application 12. In the control, the communication control unit 100 permits or rejects communication based on a combination of the physical port 11 to which the device 20 is connected and the communication application 12 used by the device 20. The detail configuration of the communication control unit 100 will be described by using FIG. 2.

FIG. 2 is a block diagram of the communication apparatus 10 according to the present example embodiment. In FIG. 2, arrows represent main dataflows, and there may be other dataflows than those illustrated in FIG. 2. In FIG. 2, each block indicates a configuration in a unit of function rather that in a unit of hardware (device). Therefore, the block illustrated in FIG. 2 may be implemented in a single device or may be implemented independently in a plurality of devices. Transmission and reception of data between blocks may be performed by any component, such as a data bus, a network, a portable storage medium, or the like.

The communication apparatus 10 has the communication control unit 100, which is a processing unit, and a storage unit 150. The communication control unit 100 includes a registration information acquisition unit 110, a communication information acquisition unit 120, a communication determination unit 130, and a communication execution unit 140. The storage unit 150 includes a combination table storage unit 151 and a system information storage unit 152. Further, the communication apparatus 10 has the physical port 11 to which the device 20 is connected and executes the communication application 12 that relays communication between the device 20 and the external device 30.

In the combination table storage unit 151, a combination in which the physical port 11 to which the device 20 is connected (specifically, a port number, which is an identifier for identifying the physical port 11) and the communication application 12 used by the device 20 (specifically, an ID, which is an identifier for identifying the communication application 12) are associated with each other is pre-stored as a combination table. Since the communication apparatus 10 according to the present example embodiment permits only the communication which relies on the combination registered in the combination table storage unit 151, the combination registered in the combination table storage unit 151 functions as a whitelist.

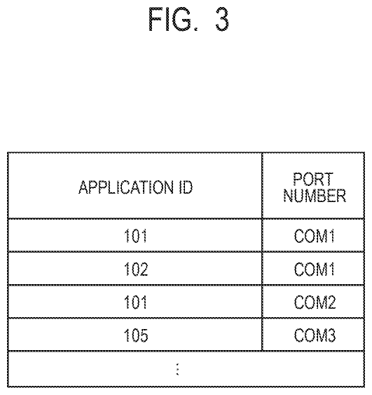

FIG. 3 is a schematic diagram of an exemplary combination table registered in the combination table storage unit 151 according to the present example embodiment. As illustrated in FIG. 3, the combination table includes at least one combination of an ID of the communication application 12 and a port number of the physical port 11. The ID of the communication application 12 and the port number of the physical port are defined by any expression scheme such as a character string, a numerical value, a binary value, or the like, respectively. One communication application 12 may be associated with a plurality of physical ports 11, and conversely one physical port 11 may be associated with a plurality of communication applications 12. A user registers a combination of a communication application 12 and a physical port 11 intended to permit communication in the combination table or deletes the combination intended to reject communication from the communication table.

While the combination table is represented by a table of character strings for visibility in FIG. 3, the combination table may be represented in any data form (file form), which may be, for example, binary data or text data. Further, the combination table may be stored as a table of a database in the combination table storage unit 151 or may be stored as a binary file or a text file in the combination table storage unit 151.

The registration information acquisition unit 110 acquires the combination of the physical port 11 and the communication application 12 from the combination table storage unit 151. Specifically, first, at occurrence of a new session of communication, the registration information acquisition unit 110 acquires the ID of the communication application 12 intended for communication (that is, scheduled to communicate). The communication application 12 intended for communication is executed by a system of the communication apparatus 10 in response to the device 20 being connected to the communication apparatus 10, and the ID of the communication application 12 is easily acquired from the system. Occurrence of the new session of communication and the communication application 12 intended for communication of interest are detected by the device 20 transmitting and receiving a SYN packet and an ACK packet via the communication application 12 (that is, three-way handshaking), for example. The registration information acquisition unit 110 then acquires the port number of the physical port 11 associated with the acquired ID of the communication application 12 from the combination table storage unit 151. Thereby, the registration information acquisition unit 110 can acquire the combination of the communication application 12 and the physical port 11 registered in advance that can be permitted for communication.

The system information storage unit 152 stores information on a system that operates the communication application 12 in the communication apparatus 10 (more specifically, an operating system). System information includes information indicating the communication application 12 that actually uses each physical port 11. The system information stored in the system information storage unit 152 is updated by the system at any time.

The communication information acquisition unit 120 acquires the information on the communication application 12 that uses the physical port 11 from the system information storage unit 152. Specifically, first, the communication information acquisition unit 120 acquires the port number of the physical port 11 acquired from the combination table storage unit 151 by the registration information acquisition unit 110. The communication information acquisition unit 120 then acquires the ID of the communication application 12 that uses the acquired port number of the physical port from the system information storage unit 152. Thereby, the communication information acquisition unit 120 can acquire the combination of the communication application 12 and the physical port 11 intended for actual communication.

The communication determination unit 130 compares the combination acquired from the combination table storage unit 151 with the combination acquired from the system information storage unit 152 and determines whether or not there is a matching.

Specifically, first, the communication determination unit 130 acquires the ID of the communication application 12 acquired by the registration information acquisition unit 110 and acquires the ID of the communication application 12 acquired by the communication information acquisition unit 120. The ID of the communication application 12 acquired by the registration information acquisition unit 110 and the ID of the communication application 12 acquired by the communication information acquisition unit 120 are associated with the common physical port 11. Therefore, to compare the IDs of the communication application 12 with each other has the same meaning as to compare the combinations of the communication application 12 and the physical port 11 with each other. Consequently, the communication determination unit 130 determines whether or not there is a matching between the ID of the communication application 12 acquired by the registration information acquisition unit 110 and the ID of the communication application 12 acquired by the communication information acquisition unit 120.

The communication execution unit 140 permits or rejects communication of the device 20 that uses the communication application 12 based on the determination of the communication determination unit 130 as to whether or not there is a matching between the combination acquired from the combination table storage unit 151 and the combination acquired from the system information storage unit 152.

Specifically, the communication execution unit 140 acquires a determination result of the communication determination unit 130. The communication execution unit 140 then transfers information indicating permission of communication of the device 20 to the communication application 12 when it is determined that there is a matching between the ID of the communication application 12 acquired by the registration information acquisition unit 110 and the ID of the communication application 12 acquired by the communication information acquisition unit 120. The communication execution unit 140 transfers information indicating a rejection of communication of the device 20 to the communication application 12 when it is determined that there is no matching between the ID of the communication application 12 acquired by the registration information acquisition unit 110 and the ID of the communication application 12 acquired by the communication information acquisition unit 120.

The communication application 12 performs communication of the device 20 when receiving information that permits communication from the communication execution unit 140 and does not perform communication of the device 20 when receiving information that rejects communication from the communication execution unit 140.

The specific processes by the communication apparatus 10 illustrated here is an example, and the communication apparatus 10 may perform any process that can determine whether or not to permit communication based on the combination of the physical port 11 and the communication application 12 registered in advance and on the combination of the physical port 11 and the communication application 12 used for actual communication.

In the present example embodiment, while a method that permits communication of the combination of the physical port 11 and the communication application 12 registered in advance (that is, a whitelist scheme) is used, the method is not limited thereto and may be a scheme that rejects communication of the combination of the physical port 11 and the communication application 12 registered in advance (that is, a blacklist scheme). In the case of the blacklist scheme, permission and rejection of communication by the communication execution unit 140 may be reversed.

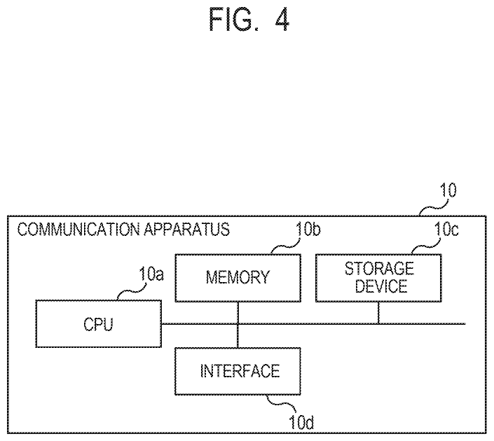

FIG. 4 is a general configuration diagram illustrating an exemplary device configuration of the communication apparatus 10 according to the present example embodiment. The communication apparatus 10 has a central processing unit (CPU) 10a, a memory 10b, a storage device 10c, and an interface 10d. The communication apparatus 10 may be a standalone device or configured integrally with another device.

The interface 10d is a communication unit that transmits and receives data and is configured to be able to perform at least one of communication schemes of wired communication and wireless communication. The interface 10d includes a processor, an electric circuit, an antenna, a connection terminal, or the like required for the above communication scheme. The interface 10d communicates using the communication scheme in accordance with a signal from the CPU 10a. The interface 10d includes the physical port 11 illustrated in FIG. 1.

The storage device 10c stores a program executed by the communication apparatus 10, data of processing result obtained by the program, or the like. The storage device 10c includes a read only memory (ROM) dedicated to reading, a hard disk drive or a flash memory that is readable and writable, or the like. Further, the storage device 10c may include a computer readable portable storage medium such as a CD-ROM. The memory 10b includes a random access memory (RAM) or the like that temporarily stores data being processed by the CPU 10a or a program and data read from the storage device 10c.

The CPU 10a is a processer that temporarily stores temporary data used for processing in the memory 10b, reads a program stored in the storage device 10c, and executes various processing operations such as calculation, control, determination, or the like on the temporary data in accordance with the program. Further, the CPU 10a stores data of a processing result in the storage device 10c and also transmits data of the processing result externally via the interface 10d.

In the present example embodiment, the CPU 10a functions as the communication control unit 100 in FIG. 2, that is, the registration information acquisition unit 110, the communication information acquisition unit 120, the communication determination unit 130, the communication execution unit 140, and the communication application 12 by executing a program stored in the storage device 10c. Further, in the present example embodiment, the storage device 10c functions as the storage unit 150 in FIG. 2, that is, the combination table storage unit 151 and the system information storage unit 152.

The communication apparatus 10 is not limited to the specific configuration illustrated in FIG. 4. The communication apparatus 10 is not limited to a single device and may be configured such that two or more physically separated devices are connected by wired or wireless connection. Respective units included in the communication apparatus 10 may be implemented by an electric circuitry, respectively. The electric circuitry here is a term conceptually including a single device, multiple devices, a chipset, or a cloud.

Further, at least a part of the communication apparatus 10 may be provided in a form of Software as a Service (SaaS). That is, at least some of the functions for implementing the communication apparatus 10 may be executed by software executed via a network.

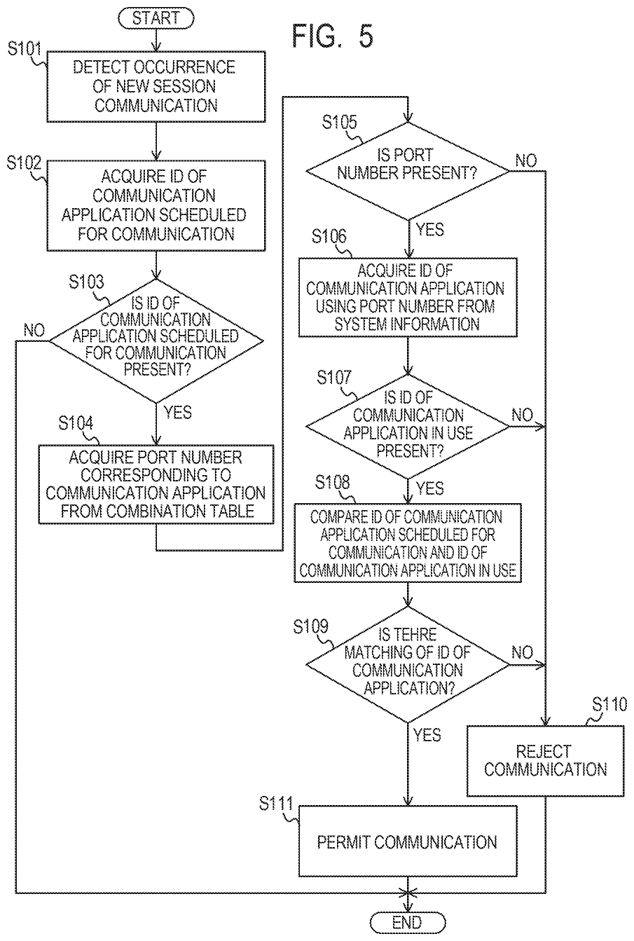

FIG. 5 is a diagram illustrating a flowchart of a communication control method using the communication apparatus 10 according to the present example embodiment. The flowchart illustrated in FIG. 5 is started, for example, in response to a new session of communication occurring in the communication apparatus 10.

First, the registration information acquisition unit 110 detects occurrence of a new session of communication (step S101) and acquires the ID of the communication application 12 intended for the communication (that is, scheduled for communication) from the system of the communication apparatus 10 (step S102). Occurrence of the new session of communication and the communication application 12 intended for the communication of interest are detected by the device 20 transmitting and receiving a SYN packet and an ACK packet via the communication application 12 (that is, three-way handshaking), for example.

If the ID of the communication application 12 intended for communication cannot be acquired (step S103, NO), the process ends.

If the ID of the communication application 12 intended for communication can be acquired (step S103, YES), the registration information acquisition unit 110 acquires, from the combination table storage unit 151, the port number of the physical port 11 associated with the ID of the communication application 12 acquired in step S102 (step S104). That is, the ID of the communication application 12 acquired in step S102 and the port number of the physical port 11 acquired in step S104 correspond to a combination registered in advance in the combination table storage unit 151.

If the port number of the physical port 11 is not acquired from the combination table storage unit 151 in step S104 (for example, when the combination including the ID of the communication application 12 is not registered in the combination table storage unit 151), (step S105, NO), the communication execution unit 140 rejects communication of the device 20 by the communication application 12 (step S110), and the process ends.

If the port number of the physical port 11 is acquired from the combination table storage unit 151 in step S104 (step S105, YES), the communication information acquisition unit 120 acquires the ID of the communication application 12 using the port number of the physical port 11 acquired in step S104 from the system information storage unit 152 (step S106). That is, the ID of the communication application 12 acquired in step S106 and the port number of the physical port 11 acquired in step S104 correspond to the combination intended for actual communication.

If the ID of the communication application 12 using the port number of the physical port 11 is not acquired from the system information storage unit 152 in step S106 (for example, the communication application 12 using the port number of the physical port 11 is not present), (step S107, NO), the communication execution unit 140 rejects communication of the device 20 by the communication application 12 (step S110), and the process ends.

If the ID of the communication application 12 using the port number of the physical port 11 is acquired from the system information storage unit 152 in step S106 (step S107, YES), the communication determination unit 130 determines whether or not there is a matching between the ID of the communication application 12 acquired in step S102 and the ID of the communication application 12 acquired in step S106 (step S108). Since both of the ID of the communication application 12 acquired in step S102 and the ID of the communication application 12 acquired in step S106 correspond to the common port number of the physical port 11, this determination is based on the combination of the communication application 12 and the physical port 11 registered in advance in the combination table storage unit 151 and on the combination of the physical port 11 and the communication application 12 intended for actual communication.

If it is determined that there is no matching between the IDs of the communication applications 12 in step S108 (step S109, NO), the communication execution unit 140 rejects communication of the device 20 by the communication application 12 (step S110), and the process ends.

If it is determined that there is a matching of the IDs of the communication application 12 in step S108 (step S109, YES), the communication execution unit 140 permits communication of the device 20 by the communication application 12 (step S111), and the process ends.

The CPU 10a of the communication apparatus 10 is the subject of each step (process) included in the communication control method illustrated in FIG. 5. That is, the CPU 10a reads a program used for performing the communication control method illustrated in FIG. 5 from the memory 10b or the storage device 10c and performs the communication control method illustrated in FIG. 5 by executing the program and controlling each unit of the communication apparatus 10.

In IoT, various devices may be connected to a network regardless of an IP device or a non-IP device. When communication availability is determined only by a communication application as with the technology described in Patent Literature 1, it is not possible to control communication in detail on a connected device basis. Further, since the conventional security countermeasures are often based on a use of an IP device as with the technology described in Patent Literature 2, it is not possible to apply such security countermeasures to a non-IP device.

In contrast, since the communication apparatus 10 according to the present example embodiment determines communication availability based on the combination of the physical port 11 to which the device 20 is connected and the communication application 12 used by the device 20, it is not necessary to use TCP/IP information, and thus communication control can be performed not only on an IP device but also on a non-IP device. Further, even with the same communication application 12, communication availability can be changed for each physical port 11 to which the device is connected, and it is therefore possible to perform detail control.

### Second Example Embodiment

In the first example embodiment, a combination of the physical port 11 and the communication application is used for determination of communication availability, whereas setting information of a system is further used in the present example embodiment. In the present example embodiment, the same configuration as that of the first example embodiment illustrated in FIG. 2 and FIG. 4 is used.

In the combination table storage unit 151 according to the present example embodiment, setting information on the system related to communication is additionally pre-stored as a combination table in association with information on the physical port 11 and the communication application 12, which is the same as that of the first example embodiment. Setting information on the system related to communication is setting information referenced to in the system of the communication apparatus 10 when the device 20 connected to the physical port 11 performs communication by using the communication application 12.

The communication determination unit 130 and the communication execution unit 140 according to the present example embodiment determine the communication availability based on setting information on the system related to the communication in addition to information on the physical port 11 and the communication application 12. Therefore, even when an unauthorized device 20 is accidentally connected to an authorized physical port 11, communication can be rejected unless there is a matching of the setting information on the system.

As the setting information on the system related to the communication, an I/O address and a baud rate are used in the present example embodiment. The I/O address (also referred to as an I/O port address) is an identifier used for identifying a virtual window used by the system of the communication apparatus 10 (in particular, the CPU 10a) for inputting and outputting data. A different I/O address is allocated to each physical port 11. The baud rate is a speed (unit) at which data is transmitted particularly in serial transmission. The baud rate is set to a desired value by a user from values available in accordance with the type of the physical port 11 (serial port in this case). To determine the communication availability, either one of the I/O address and the baud rate, but not both, may be used. Other information used in communication as setting information of a system may be used without being limited to those illustrated here.

Further, the system information stored in the system information storage unit 152 includes setting information on the system related to the communication (here, the I/O address and the baud rate) in addition to information indicating the communication application 12 that actually uses each physical port 11. The system information stored in the system information storage unit 152 is updated by the system at any time.

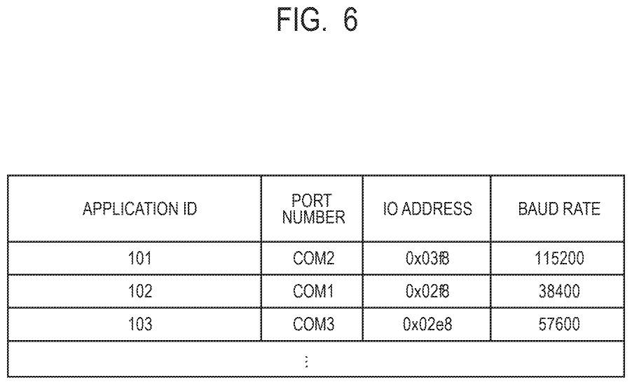

FIG. 6 is a schematic diagram of the combination table registered in the combination table storage unit 151 according to the present example embodiment. As illustrated in FIG. 6, the combination table includes at least one combination of the ID of the communication application 12, the port number of the physical port 11, the I/O address of the physical port 11, and the baud rate of the physical port 11. The user registers a combination of the communication application 12, the physical port 11, the I/O address, and the baud rate intended to permit communication in the combination table or deletes the combination intended to reject communication from the combination table.

While the combination table is represented by a table of character strings for visibility in FIG. 6, the combination table may be represented in any data form (file form), which may be, for example, binary data or text data. Further, the combination table may be stored as a table of database in the combination table storage unit 151 or may be stored as a binary file or a text file in the combination table storage unit 151.

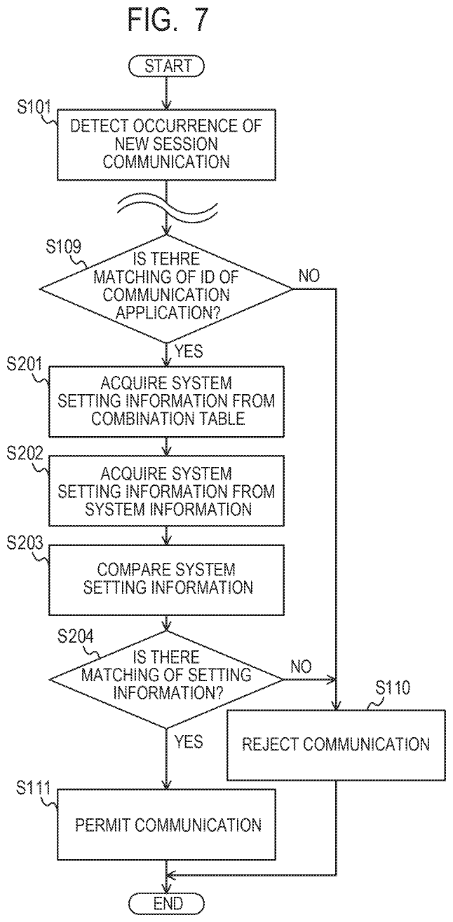

FIG. 7 is a diagram illustrating a flowchart of the communication control method using the communication apparatus 10 according to the present example embodiment. The flowchart illustrated in FIG. 7 is started in response to a new session of communication occurring in the communication apparatus 10, for example.

Prior to the start of the flowchart in FIG. 7, the user manually sets the setting information of the I/O address and the baud rate in the system and registers the same setting information in the combination table storage unit 151 (not illustrated in FIG. 7). Since the probability of an unintended matching of the setting information increases when the I/O address and the baud rate automatically set by the system (that is, by default) are used, it is desirable to use a value different from the I/O address and the baud rate automatically set by the system as the setting information.

First, the communication apparatus 10 performs the same steps S101 to S109 as those in the flowchart in FIG. 5.

If it is determined that there is a matching of the IDs of the communication application 12 (step S109, YES), the registration information acquisition unit 110 acquires the setting information (the I/O address and the baud rate) of the system associated with the ID of the communication application 12 acquired in step S102 from the combination table storage unit 151 (step S201).

The communication information acquisition unit 120 acquires the setting information (the I/O address and the baud rate) of the system associated with the ID of the communication application 12 acquired in step S102 from the system information storage unit 152 (step S202).

The communication determination unit 130 determines whether or not there is a matching between the setting information on the system acquired in step S201 and the setting information on the system acquired in step S202 (step S203).

If it is determined that there is no matching of the setting information on the system in step S203 (step S204, NO), the communication execution unit 140 rejects the communication of the device 20 by the communication application 12 (step S110), and the process ends.

If it is determined that there is a matching of the setting information on the system in step S203 (step S204, YES), the communication execution unit 140 permits the communication of the device 20 by the communication application 12 (step S111), and the process ends.

The CPU 10a of the communication apparatus 10 is the subject of each step (process) included in the communication control method illustrated in FIG. 7. That is, the CPU 10a reads a program used for performing the communication control method illustrated in FIG. 7 from the memory 10b or the storage device 10c and performs the communication control method illustrated in FIG. 7 by executing the program and controlling each unit of the communication apparatus 10.

Also in the present example embodiment, it is possible to perform detail communication control regardless of an IP device or a non-IP device in the same manner as in the first example embodiment. Further, in the present example embodiment, communication control is performed based on setting information on the system related to communication in addition to the combination of the physical port 11 and the communication application 12. Therefore, even when an unauthorized device 20 is accidentally connected to an authorized physical port 11, communication is rejected unless there is a matching of setting information on the system, and it is therefore possible to further improve security.

### Third Example Embodiment

In the first example embodiment, the communication control method is performed in response to a new session of communication occurring in the communication apparatus 10, whereas in the present example embodiment, the communication control method is periodically performed by timer management or the like. In the present example embodiment, the same configuration as that of the first example embodiment illustrated in FIG. 2 and FIG. 4 is used.

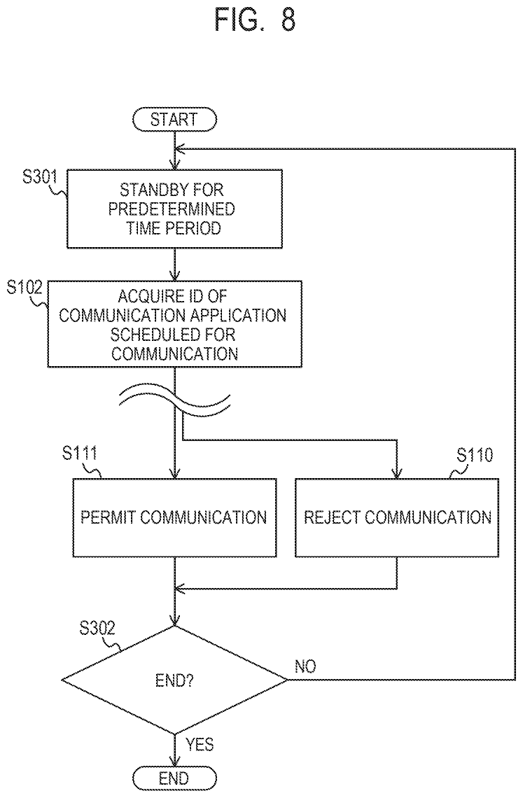

FIG. 8 is a diagram illustrating a flowchart of a communication control method using the communication apparatus 10 according to the present example embodiment. The flowchart illustrated in FIG. 8 is started when the communication apparatus 10 is started up, for example.

The communication apparatus 10 stands by for a predetermined time period (step S301). The time period for standby corresponds to a time interval for monitoring communication by the device 20 and is preset to any value by the user. Further, the time period for standby may be automatically set and changed by the communication apparatus 10.

Next, the communication apparatus 10 performs the same steps S102 to S111 as those in the flowchart of FIG. 5.

If a predetermined termination condition is satisfied (step S302, YES), the communication apparatus 10 ends the process. If the predetermined termination condition is not satisfied (step S302, NO), the communication apparatus 10 transfers the process back to step S301 and repeats the process. The termination condition is that the user performs an operation for terminating the process on the communication apparatus 10, for example.

The CPU 10a of the communication apparatus 10 is the subject of each step (process) included in the communication control method illustrated in FIG. 8. That is, the CPU 10a reads a program used for performing the communication control method illustrated in FIG. 8 from the memory 10b or the storage device 10c and performs the communication control method illustrated in FIG. 8 by executing the program and controlling each unit of the communication apparatus 10.

Also in the present example embodiment, it is possible to perform detail communication control regardless of an IP device or a non-IP device in the same manner as in the first example embodiment. Further, in the present example embodiment, since communication is periodically monitored by the device 20, it is possible to determine permission or rejection of communication by the device 20 even at a timing other than the time of starting a new session.

### Other Example Embodiments

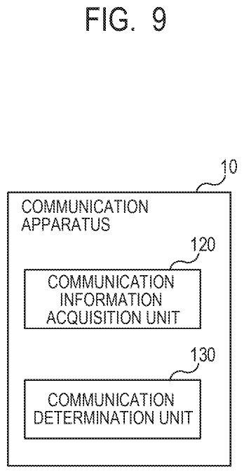

FIG. 9 is a general configuration diagram of the communication apparatus 10 according to each of the example embodiments described above. FIG. 9 illustrates a configuration example by which the communication apparatus 10 functions as a device that performs communication control based on a combination of the physical port and the communication application to which the device is connected. The communication apparatus 10 executes the communication application configured to control communication and has a physical connection portion, and the communication apparatus 10 includes the communication information acquisition unit 120 that acquires a combination of the physical connection portion and the communication application used for communication performed from a device connected to the physical connection portion to the outside of the communication apparatus and the communication determination unit 130 that determines whether or not to permit the communication based on the combination used for the communication and a pre-registered combination of the physical connection portion and the communication application.

The present invention is not limited to the example embodiments described above and can be properly changed within the scope not departing from the spirit of the present invention.

The scope of each of the example embodiments also includes a processing method that stores, in a storage medium, a program that causes the configuration of each of the example embodiments to operate so as to implement the function of each of the example embodiments described above (more specifically, a communication control program that causes a computer to perform the process illustrated in FIG. 5, FIG. 7, and FIG. 8), reads the program stored in the storage medium as a code, and executes the program in a computer. That is, the scope of each of the example embodiments also includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

### Supplementary Note 1

A communication control method comprising steps of:

acquiring, at a communication apparatus that executes a communication application configured to control communication and has a physical connection portion, a combination of the physical connection portion and the communication application used for the communication performed from a device connected to the physical connection portion to outside of the communication apparatus; and

determining whether or not to permit the communication based on the combination used for the communication and a combination of the physical connection portion and the communication application registered in advance.

### Supplementary Note 2

The communication control method according to supplementary note 1, wherein the step of determining permits the communication when there is a matching between the combination used for the communication and the combination registered in advance and rejects the communication when there is no matching between the combination used for the communication and the combination registered in advance.

### Supplementary Note 3

The communication control method according to supplementary note 1 or 2, wherein the device performs the communication by using a method other than TCP/IP.

### Supplementary Note 4

The communication control method according to any one of supplementary notes 1 to 3, wherein the physical connection portion is a serial port.

### Supplementary Note 5

The communication control method according to any one of supplementary notes 1 to 4, wherein the step of determining determines whether or not to permit the communication based on setting information set for the physical connection portion in addition to the physical connection portion and the communication application.

### Supplementary Note 6

The communication control method according to supplementary note 5, wherein the setting information indicates at least one of a baud rate and an I/O address set for the physical connection portion.

### Supplementary Note 7

The communication control method according to any one of supplementary notes 1 to 6, wherein the communication control method is performed when the communication is started.

### Supplementary Note 8

The communication control method according to any one of supplementary notes 1 to 6, wherein the communication control method is performed at a predetermined time interval.

### Supplementary Note 9

A storage medium that stores a communication control program to cause a communication apparatus that is a computer that executes a communication application configured to control communication and has a physical connection portion to perform the steps of:

acquiring a combination of the physical connection portion and the communication application used for the communication performed from a device connected to the physical connection portion to outside of the communication apparatus; and

determining whether or not to permit the communication based on the combination used for the communication and a combination of the physical connection portion and the communication application registered in advance.

### Supplementary Note 10

A communication apparatus that performs a communication application configured to control communication and has a physical connection portion, the communication apparatus comprising:

a communication information acquisition unit that acquires a combination of the physical connection portion and the communication application used for the communication performed from a device connected to the physical connection portion to outside of the communication apparatus; and

a communication determination unit that determines whether or not to permit the communication based on the combination used for the communication and a combination of the physical connection portion and the communication application registered in advance.

This application is based upon and claims the benefit of priority from Japanese Patent Application No. 2017-041347, filed on Mar. 6, 2017, the disclosure of which is incorporated herein in its entirety by reference.

1. A communication control method comprising steps of:
acquiring, at a communication apparatus that executes a communication application configured to control communication and has a physical connection portion, a combination of the physical connection portion and the communication application used for the communication performed from a device connected to the physical connection portion to outside of the communication apparatus; and
determining whether or not to permit the communication based on the combination used for the communication and a combination of the physical connection portion and the communication application registered in advance.

2. The communication control method according to claim 1, wherein the step of determining permits the communication when there is a matching between the combination used for the communication and the combination registered in advance and rejects the communication when there is no matching between the combination used for the communication and the combination registered in advance.

3. The communication control method according to claim 1, wherein the device performs the communication by using a method other than TCP/IP.

4. The communication control method according to claim 1, wherein the physical connection portion is a serial port.

5. The communication control method according to claim 1, wherein the step of determining determines whether or not to permit the communication based on setting information set for the physical connection portion in addition to the physical connection portion and the communication application.

6. The communication control method according to claim 5, wherein the setting information indicates at least one of a baud rate and an I/O address set for the physical connection portion.

7. The communication control method according to claim 1, wherein the communication control method is performed when the communication is started.

8. The communication control method according to claim 1, wherein the communication control method is performed at a predetermined time interval.

9. A non-transitory storage medium that stores a communication control program to cause a communication apparatus that is a computer that executes a communication application configured to control communication and has a physical connection portion to perform the steps of:
acquiring a combination of the physical connection portion and the communication application used for the communication performed from a device connected to the physical connection portion to outside of the communication apparatus; and
determining whether or not to permit the communication based on the combination used for the communication and a combination of the physical connection portion and the communication application registered in advance.

10. A communication apparatus comprising:
at least one memory configured to store instructions; and
at least one processor configured to execute the instructions to;
acquire a combination of a physical connection portion and a communication application used for the communication performed from a device connected to the physical connection portion to outside of the communication apparatus; and
determine whether or not to permit the communication based on the combination used for the communication and a combination of the physical connection portion and the communication application registered in advance.

11. The communication control method according to claim 2, wherein the device performs the communication by using a method other than TCP/IP.

12. The communication control method according to claim 2, wherein the physical connection portion is a serial port.

13. The communication control method according to claim 3, wherein the physical connection portion is a serial port.

14. The communication control method according to claim 2, wherein the step of determining determines whether or not to permit the communication based on setting information set for the physical connection portion in addition to the physical connection portion and the communication application.

15. The communication control method according to claim 3, wherein the step of determining determines whether or not to permit the communication based on setting information set for the physical connection portion in addition to the physical connection portion and the communication application.

16. The communication control method according to claim 4, wherein the step of determining determines whether or not to permit the communication based on setting information set for the physical connection portion in addition to the physical connection portion and the communication application.

17. The communication control method according to claim 2, wherein the communication control method is performed when the communication is started.

18. The communication control method according to claim 3, wherein the communication control method is performed when the communication is started.

19. The communication control method according to claim 4, wherein the communication control method is performed when the communication is started.

20. The communication control method according to claim 5, wherein the communication control method is performed when the communication is started.
